(19) United States
(12) Patent Application Publication
(10) Pub. No.: US 2009/0009297 A1
(43) Pub. Date: Jan. 8, 2009

(54) System for recording valve actuation information

(76) Inventors: Tsutomu Shinohara, Osaka (JP); Nobukazu Ikeda, Osaka (JP); Michio Yamaji, Osaka (JP); Toshio Doh, Osaka (JP); Kouji Nishino, Osaka (JP); Shinichi Ozaki, Osaka (JP); Toshihiro Matsumoto, Osaka (JP)

Correspondence Address: KEVIN J. MCNEELY, ESQ., 5335 WISCONSON AVENUE, NW, SUITE 440, WASHINGTON, DC, 20015, US

(21) Appl. No.: 12/154,695

(22) Filed: May 27, 2008

(30) Foreign Application Priority Data
May 21, 2007 (JP) 2007-134719

(51) Int. Cl. H04Q 5/22

(52) U.S. Cl. 340/10.4

(57) ABSTRACT

The present invention provides a system for recording valve actuation information that enables to figure out the actual operation condition of each individual valve without checking plural valves individually, and the valves do not have to be wired, and the structure of the system is simple.

The present invention is a system for recording valve actuation information comprising a valve, detecting means for detecting actuation of said valve, a RFID tag affixed to said valve and recording the valve actuation information detected by said detecting means, and a terminal for reading out the valve actuation information detected by said detecting means, wherein said RFID tag searches said terminal by intermittently transmitting a radio wave, wherein said RFID tag transfers the valve actuation information recorded in said RFID tag to said terminal when said RFID tag detects said terminal.

### CROSS REFERENCE TO RELATED APPLICATION

This is an application claiming the priority from Japanese Patent Application (JP2007-134719) filed on 21 May, 2007, which is incorporated by reference herein its entirety.

### FIELD OF THE INVENTION

This invention relates to a system for recording valve actuation information with a RFID (Radio Frequency IDentification) tag which is used for storage tanks or piping systems of various industrial machine equipments or the like.

### DESCRIPTION OF THE BACKGROUND ART

Various types of valve have been commonly used to control the flow of fluid in the industrial equipments. For example, a large number of valves are used in beer factories, dairy products factories, what is more, electric power plants, chemical plants, semiconductor factories and so on, and wherein the valve has an important role for controlling the flow amount, the direction and the pressure of fluid through pipes. Thus, when the valve breaks down during the operation of the factory, this may cause heavy losses or an accident. Therefore, the valve has required regular maintenance at pre-fixed intervals, such as every year or every half years.

However, busy valve (frequently used) and dull valve (not frequently used) are mixed and placed in a plumbing system in a factory or the like, and all the valves are uniformly disassembled for their check or repaired while the machines and various plants operation is stopped. This leads to that all valves including dull valves, which have the less likely to fail, undergo the maintenance, and which results in increasing the maintenance cost. When the valve is regularly exchanged in view of the safety management, some measurers rely on their guesses and experiences to evaluate the frequency of valve actuation without figuring out the actual operation condition of the valve. This may cause wrong evaluation of the measurer, which may result in unnecessary exchange of the dull valves. This causes increasing cost. On the contrary, when the valve is exchanged late, the valve failure causes the line stop in the factory, which results in heavy losses or accidents according to the circumstances.

To solve the above problems, for example, publication of patent application, Tokukaishou No. 64-46083 discloses that a concave portion are placed opposite to a transmitting component of a joint connecting a valve body and a working source, and a coil spring is provided in the concave portion as a service-life-detecting.

According to the disclosure, the opening and closing motions of the valve provide its repeated stress with the coil spring. After receiving the repeated stress for the predefined numbers, the coil spring has a fatigue breakdown. Thus, the service life of the valve is evaluated. Accordingly, the actual operation condition of the valve is figured out, and the valve is disassembled for its check, fixed and exchanged depending on the use frequency of the valve.

However, the coil spring, which is the service-life-detecting, is attached to each individual valve, and this causes a problem that the coil springs of all valves should be regularly checked. Particularly, in semiconductor factories or atomic power plants or the like, a few thousands or several tens-thousands of valves are installed, and therefore it is troublesome and extremely difficult to check all valves regularly.

To solve the above problems, for example, publication of patent application Tokukai No. 2000-65246 discloses an abnormality diagnostic device of motor-operated valves. In the invention, three sorts of sensors are temporarily provided at the moter-control-center which is connected to motor-operated valves. The device records the detecting signals output from the sensors, and converts the signals to specific transmission signals, and stores the accumulation of the permitted values and the diagnosis records of preset diagnostic items, and displays its normalcy or abnormality depending on the evaluation logic. Thus, the motor-operated valve information is focused on the motor-control-center, so the data is easily collected therein. In addition, it is possible to confirm whether the entire motor-operated valves are in abnormal condition or not, while an operation processing device is in remote location.

However, with the disclosure, all motor-operated valves need to be connected to the moter-control-center. This causes a problem that the line is complicated and structure is also complicated in the facility having thousands of valves.

### SUMMARY OF INVENTION

The present invention solves the above-described problems of the prior art, and provides a system for recording valve actuation information. The system enables to figure out the actual operation condition of each individual valve without checking plural valves individually, and particularly, the valves do not have to be wired, and the structure is simple.

One embodiment of the present invention relates to a system for recording valve actuation information comprising: a valve, detecting means for detecting actuation of said valve, a RFID tag affixed to said valve and recording the valve actuation information detected by said detecting means, and a terminal for reading out the valve actuation information detected by said detecting means, wherein said RFID tag searches said terminal by intermittently transmitting a radio wave, wherein said RFID tag transfers the valve actuation information recorded in said RFID tag to said terminal when said RFID tag detects said terminal.

Another embodiment of the present invention relates to a system for recording valve actuation information, wherein said detecting means is a limit switch.

Another embodiment of the present invention relates to a system for recording valve actuation information, wherein said terminal sends information to said RFID tag.

Another embodiment of the present invention relates to the system for recording valve actuation information, wherein said intermittent transmission includes repetition between radio wave transmission for 2 seconds and intermission for 5 seconds

According to the present invention, the RFID tag uses wireless communication, therefore the wiring connection is not necessary. In addition, the terminal can read out the actual operation condition of the plural valves at one time without checking each individual valve, therefore the system for recording valve actuation information has a simple structure.

The RFID tag searches the terminal by intermittently transmitting a radio wave, and the RFID tag transfers the valve actuation information recorded in the RFID tag to the terminal only when the RFID tag detects the terminal. This results in providing the longer service life of the battery attached to the RFID tag than the one attached to the RFID tag transmitting the radio wave continuously.

According to the present invention, the detecting means is a limit switch, which enables to detect the valve actuation information accurately with a simple structure.

According to the present invention, the terminal sends information to the RFID tag, which results in not only reading out information from the RFID tag but also writing information included in the terminal into the RFID tag.

According to the present invention, the RFID tag intermittently repeats radio wave transmission for 2 seconds and intermission for 5 seconds in alternate shifts. Even the terminal is carried and moved for 5 minutes on foot, the movement distance is within the receiving range of the RFID tag (15 m to 20 m), which results in detecting all valves certainly and extending the battery life.

### BRIEF DESCRIPTION OF THE DRAWINGS

Hereinafter, preferred embodiments of the system for recording valve actuation information according to the present invention will be explained with reference to the drawings.

FIG. 1 is a structural diagram of a valve with RFID tag in a system for recording valve actuation information according to the present invention.

FIG. 2 is a diagram showing an actual usage of a system for recording valve actuation information according to the present invention.

FIG. 3 is a diagram showing the actuation of the RFID tag of a system for recording valve actuation information according to the present invention.

### DESCRIPTION OF THE PREFERRED EMBODIMENTS

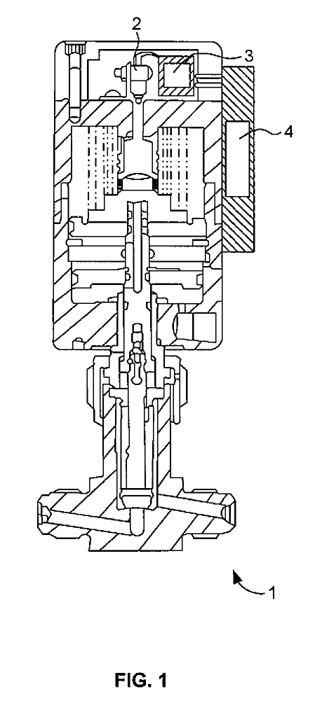

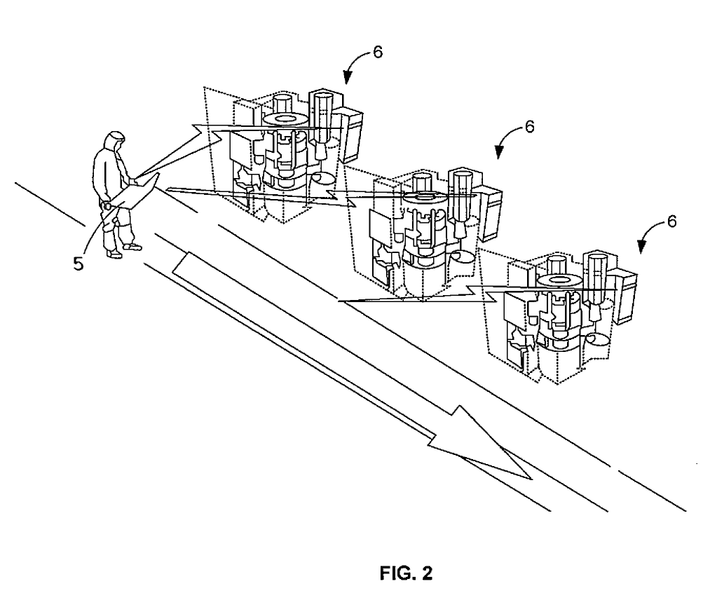

FIG. 1 is a structural diagram of a valve with RFID tag in a system for recording valve actuation information according to the present invention. FIG. 2 is a diagram showing an actual usage of a system for recording valve actuation information according to the present invention.

A system for recording valve actuation information according to the present invention comprises a valve (1), detecting means (2) and RFID (Radio Frequency-IDentification) tag (3) shown in FIG. 1, and a terminal (5) shown in FIG. 2.

The valve (1) is an apparatus having a mechanism which opens and closes an access passage to run fluid, stop fluid or control the flow rate. For example, gate valve, glove valve, ball valve, butterfly valve or the like may be used in the present invention. In FIG. 1, the glove valve is shown as an example. The present invention may be applied for not only the valves automatically switching its opening and closing such as electromagnetic valve and moter-operated valve, but also manual valves manually switching its opening and closing.

The fluid passing through the valve (1) is not limited to liquid or gas. In addition, the system for recording valve actuation information according to the present invention may be used for the valve placed in various pipes for fluid, such as water, air, gas, oil or the like.

The detecting means (2) detects valve actuation. When moter-operated valve or electromagnetic valve is used as a valve, the detecting means (2) may be a device detecting the open and close signals output from a valve control device to the valve. By contrast, when manual valve is used, the open and close signals from the valve control device to the valve are not output, therefore it is desirable to detect the valve actuation by using a limit switch as the detecting means (2).

However, even when the moter-operated valve is used as the valve, the open and close signals may not show enough whether the valve actually actuates or not. Thus, to figure out the valve actuation accurately, it is preferable to use the limit switch as the detecting means (2) and detect the valve actuation with the limit switch.

When the limit switch is used as the detecting means (2), the limit switches are placed in order to detect fully-open condition and fully-close condition of the valve. When the valve is fully-opened and fully-closed alternately, the valve actuation may be detected only by placing the limit switch for either the fully-open condition or fully-close condition. For example, in the valve shown in FIG. 1, the limit switch is placed as the detecting means (2) in order to detect the valve actuation when the valve is in the fully-open condition.

The RFID tag (3) records the valve actuation information detected by the detecting means (2) and sends the information to the terminal. As for the RFID tag (3), an active tag incorporating a transceiver connecting a battery with an antenna is used in the present invention. The reason is that the above-RFID tag (3) itself enables to emit radio wave, and therefore the communication may work in a long distance (15 to 20 m), and the plural valves can be read out by the terminal at one time. By contrast, if a passive tag is used as the RFID tag (3), the communication distance may work in a short distance (a few centimeters), and the terminal needs to be close to each individual valve, and the plural valves may not be read out by the terminal at one time. Thus, the passive tag is not used in the system for recording valve actuation information of the present invention. The RFID tag (3) records not only the valve actuation information but also other information such as valve control number, valve name, type, bore diameter, manufacture name, part number, lot number, manufactured date, and exchanged date.

The radio wave transmission of the RFID tag (3) is preferably performed by intermittently repeating radio wave transmission for 2 seconds and intermission for 5 seconds in alternate shifts. The reason is that the RFID tag (3) permits to send and receive the radio wave in 15 m to 20 m. Even when the terminal (5) is carried and moved as shown in FIG. 2, the terminal enables to certainly receive the radio wave transmitted from the RFID tag (3) at 5 seconds intermission intervals. Accordingly, the valve actuation information (1) is detected definitely, and the battery life is extended. When the radio wave is intermitted for less than or equal to 4 seconds, the battery is used heavily, and the effectiveness of extending the battery life is reduced. When the radio wave is intermitted for more than or equal to 6 seconds, the terminal may not receive the radio wave from RFID tag (3) while the terminal is in motion, and may not detect the actuation information of all valves. Thus, they are inappropriate. In addition, when the radio wave is transmitted for 1 second, the terminal may not detect the radio wave transmitted by RFID tag. When the radio wave is transmitted for more than or equal to 3 seconds, the battery is used heavily, and the battery life can not be extended. Thus, they are also inappropriate.

As for the battery (4), many kinds of batteries such as manganese battery, alkaline-manganese battery, nickel system primary battery, oxyride battery, silver oxide battery, and lithium-ion battery may be used. Also, many types of batteries such as dry cell battery and button battery may be used. In the present invention, lithium-ion battery is preferably used because this battery has few voltage drops by the end of the electric charge, few self-discharge, and relatively long service life.

The transceiver connected to an antenna sends information to the terminal (5) and receives information from the terminal (5) by transmitting radio wave from the antenna. As for the transmission frequency when the transceiver communicates with the terminal (5), many kinds of transmission frequency has been conventionally used, and in the present invention, the range of 860-960 MHz or 2.4-2.5 GHz is preferably used. The reason is that, when the range of 860-960 MHz is used, the diffraction of the radio wave is expected and the communication is worked even there are one or more barriers. Further, when the range of 2.4-2.5 GHz is used, the antenna is compact.

The terminal (5) receives the radio wave transmitted by the RFID tag (3), and records the information recorded in the RFID tag (3). The transceiver is provided in the terminal (5) to receive the information from the RFID tag (3). For example, a notebook computer connected with the transceiver is used as the terminal (5). In addition, the system for recording valve actuation information of the present invention is capable of sending and receiving information between the RFID tag (3) and the terminal (5), therefore the information can be sent from the terminal (5) to the RFID tag (3), and the information can be written from the terminal (5) into the RFID tag (3).

Next, according to the system for recording valve actuation information of the present invention, the method for recording the valve actuation information will be explained.

In the valve (1) shown in FIG. 1, the detecting means (2) for detecting fully-open condition is provided, and a limit switch is used as the detecting means (2).

When the valve (1) is in the fully-open condition, the detecting means (2) detects the open condition of the valve (1) (step 1). The detecting means (2) records the detected actuation information of the valve (1) in the RFID tag (3) (step 2). Every time the valve (1) opens and closes, the step 1 and the step 2 are repeated, and the actuation information detected by the detecting means (2) is recorded in the RFID tag (3) accumulatively.

The RFID tag (3) recording the valve actuation information of the valve (1), apart from the actuation of the step 1 and 2, searches whether the terminal (5) exists in the transmitting-receiving area of the RFID tag (3) or not by intermittently transmitting the radio wave (step 3). In the step, the RFID tag (3) only searches the terminal (5), and does not transmit the information of the RFID tag (3). The RFID tag (3) intermittently transmits the radio wave and does not send the recorded information until the terminal (5) is confirmed, and transmits the radio wave only for the purpose of confirming the terminal (5). This results in preventing the battery (4) attached to the RFID tag from using heavily, and extending its battery life.

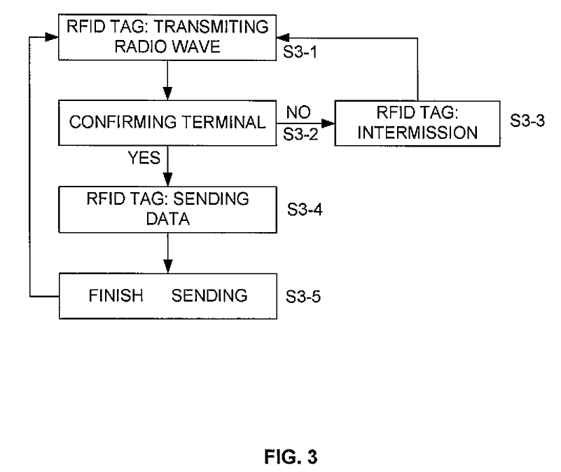

Specifically, the searching actuation of the step 3 will be explained with reference to FIG. 3.

The RFID tag (3) transmits the radio wave at specified time intervals (for example 2 seconds) (step 3-1), the RFID tag (3) searches the terminal (5) within the transmitting-receiving area of the RFID tag (3) (step 3-2). When the terminal (5) (the signal from the terminal (5)) is not confirmed, the RFID tag (3) stops transmitting the radio wave and intermits at specified time intervals (for example 5 seconds) (step 3-3). After passing the specified time intervals (for example 5 seconds), the RFID tag (3) transmits the radio wave at specified time intervals (for example 2 seconds) (step 3-1) again, and searches the terminal (5) (step 3-2) again.

The RFID tag (3) repeats the transmission of the radio wave at specified time intervals (for example 2 seconds) (step 3-1) and the intermission at specified time intervals (for example 5 seconds) (step 3-3) until confirming the terminal (5).

When the RFID tag (3) transmits the radio wave at specified time intervals (for example 2 seconds) (step 3-1), the RFID tag (3) searches the terminal (5) within the transmitting-receiving area of the RFID tag (3) (step 3-2), and further, when the terminal (5) (the signal from the terminal (5)) is confirmed, the RFID tag (3) transmits the recorded actuation information of the valve (1) to the terminal (5) (step 3-4). The display of the terminal (5), which receives the actuation information of the valve (1) from RFID tag (3) (for example the display of the notebook computer connected to the terminal (5)), shows the information of the valve (1), and the actual operation condition is figured out.

In addition, the information is transmitted and received between the RFID tag (3) and the terminal (5), and therefore the information included in the terminal (5) may be written into the RFID tag (3). For example, the date when the terminal (5) receives information from RFID tag (3) may be written into the RFID tag (3).

When the terminal (5) is moved to the outside of the transmitting-receiving area of the RFID tag (3) after finishing the communication between RFID tag (3) and the terminal (5) (step 3-5), the RFID tag (3) is unable to confirm the terminal (5) (step 3-2) by transmitting the radio wave (step 3-1), therefore the RFID tag (3) intermits at specified time intervals (for example 5 seconds) (step 3-3). After that, the RFID tag (3) transmits the radio wave at specified time intervals (for example 2 seconds) (step 3-1) again, and searches the terminal (5) (step 3-2) again.

RFID tag (3) repeats a transmission of the radio wave at the above-specified time intervals (for example 2 seconds) and an intermission at the above-specified time intervals (for example 5 seconds) (step 3-1 to step 3-3) until confirming the terminal (5).

As shown in FIG. 2, during the step 3-1 to 3-5, a measurer passes the area adjacent to the valve (1) by carrying the terminal (5). As described above, after confirming the terminal (5), the RFID tag (3) sends the recorded information to the terminal (5). Thus, the measurer can obtain the actuation information of the plural valves (1) at one time by carrying the terminal (5), and by passing the nearby area of the device (6) in which the plural valves (1) incorporating the RFID tag (3) are placed.

In the present invention, when the valve actuation information is collected, each individual valve does not have to be confirmed by being disassembled. Thus, when the actuation information of the valve (1) is collected, dust or dirt does not float freely in the air, and therefore the system of the present invention is preferably used in the clean room in semiconductor factories or the like.

The present invention is preferably used in a system for recording valve actuation information for figuring out the actual operation condition in the place where a large number of valves are placed, such as electric power plants, chemical plants and clean rooms in semiconductor factories.

What is claimed is:

1. A system for recording valve actuation information comprising:
a valve,
detecting means for detecting actuation of said valve,
a RFID tag affixed to said valve and recording the valve actuation information detected by said detecting means, and
a terminal for reading out the valve actuation information detected by said detecting means,
wherein said RFID tag searches said terminal by intermittently transmitting a radio wave,
wherein said RFID tag transfers the valve actuation information recorded in said RFID tag to said terminal when said RFID tag detects said terminal.

2. The system for recording valve actuation information according to claim 1, wherein said detecting means is a limit switch.

3. The system for recording valve actuation information according to claim 1, wherein said terminal sends information to said RFID tag.

4. The system for recording valve actuation information according to claim 1, wherein said intermittent transmission includes repetition between radio wave transmission for 2 seconds and intermission for 5 seconds.
